(19) United States
(12) Patent Application Publication
(10) Pub. No.: US 2003/0209310 A1
(43) Pub. Date: Nov. 13, 2003

(54) Apparatus, system and method to reduce wafer warpage

(76) Inventors: Anastacio C. Fuentes JR., Manila City (PH); Reynaldo S. Atienza JR., Manila City (PH); Chesalon M. Clavio, Paranaque City (PH)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/145,171

(22) Filed: May 13, 2002

(51) Int. Cl. B32B 31/00

(52) U.S. Cl. 156/154; 156/379.7; 156/497

(57) ABSTRACT

Typically, the frontside of a wafer is protected by a tape during backgrinding. Electrostatic charge may accumulate on the tape during the backgrinding operation. The wafer may warp after the backgrinding operation because the thinned wafer is not sufficiently rigid to counteract the bending forces resulting from the accumulation of electrostatic charge. In order to reduce wafer warpage, ionized air may be directed onto the wafer and tape to reduce the accumulation of electrostatic charge.

### FIELD OF THE INVENTION

This invention relates to fabrication of semiconductor devices and more particularly to a fabrication process of a semiconductor device including a grinding step applied to a back surface of a semiconductor substrate while protecting the front side thereof by an adhesive medium.

### BACKGROUND OF THE INVENTION

The trend towards larger and thicker wafers presents several problems in the packaging process. Thicker wafers require the more expensive saw through method at die separation. Although sawing produces a higher quality die, the process is more expensive in time and consumption of diamond tipped saws. A thicker die also requires deeper die attach cavities, resulting in a more expensive package. Both of these undesirable results are avoided by thinning the wafers before die separation. Another reason for thinning wafers is that the wafer backs are not protected during doping operations such that the dopants form electrical junctions in the wafer back. These electrical junctions may interfere with back contact conduction. As such, the wafers are thinned to remove the electrical junctions.

Typically, the wafers are thinned to a predetermined thickness by a backside grinding process. For example, the thickness of an 8-inch diameter wafer may be reduced from about 850 microns to about 180 microns or less. In backgrinding, the frontside of the wafer may be scratched and/or the wafer may broken because the wafer is held down on the grinder or polishing surface. In order to protect the wafer from such scratches and breakage, a protective tape is applied to the front surface of the wafer. Generally, the protective tape comprises a tape base and an adhesive layer. The tape base has a thickness of about 100 to 150 microns and is formed of a polymer such polyolefin, polyethylense, or polyvinyl chloride. The adhesive layer is typically an acrylic resin with a thickness of 30 to 40 microns.

A typical backgrinding apparatus comprises a supporting base and at least one grinding wheel assembly which faces the supporting base. The supporting base typically has a holding table, and the surface of the holding table protrudes beyond the surface of the supporting base. The grinding wheel assembly includes a rotatably mounted support shaft and a grinding wheel mounted to the supporting shaft. In the aforesaid backgrinding apparatus, a wafer is placed on the surface of the holding table and secured by vacuum. The grinding wheel is rotated by rotating the supporting shaft. The surface of the wafer is ground by moving the supporting base relative the grinding wheel assembly. After the wafer is ground to the predetermined thickness, the wafer is transferred to a carrier, and the carrier is transferred to a detapping apparatus where the protective tape is removed from the wafer.

One of the problems resulting from the wafer processing industry migrating to 8 inch or larger wafers is that the wafer is often too fragile for handling after the backgrinding operation, wherein the wafer is likely to be broken or damaged during subsequent handling. Furthermore, stresses induced in the wafer by the grinding and polishing process need to be controlled to prevent wafer and die warping. Wafer warping interferes with the die separation process due to die breakage, and die warping creates die attach problems in the packaging process.

Additionally, it has been observed that an electrostatic charge may accumulate on the protective tape and wafer during the grinding operation. Such accumulation of electrostatic charge warps the wafer, thereby further complicating the handling and placement of the wafers. In particular, it is often difficult to load and unload the wafers from the carrier and/or boat. For example, after grinding, the wafer is transferred by an arm mechanism to a carrier located at an exit station. If the wafer is severely warped, the arm mechanism may be unable to feed the wafer into a slot of the carrier. If the arm mechanism is able to the load the wafer into the carrier, there may be insufficient clearance for the arm mechanism to feed a subsequent wafer into the carrier. As a result, the arm mechanism may break an already loaded wafer during the loading process and/or break both the wafer being loaded and an already loaded wafer.

Another problem associated with warpage is that the wafers may be sufficiently flat such that arm mechanism is able to successfully feed all the wafers into the carrier located at the exit station. The carrier is then transferred to a detapping apparatus where the protective tape is removed from the frontside of the wafer. However, the extent of wafer warpage is enhanced by the attractive forces acting upon adjacent wafers. For example, a wafer with a positively charged frontside will be attracted to an adjacent wafer with a negatively charged backside to cause further warpage of the adjacent wafer. The increased warpage decreases the clearance between wafers to the extent that an arm mechanism may be unable to transfer a wafer from the carrier to the detapping apparatus.

### BRIEF DESCRIPTION OF THE DRAWINGS

FIG. 1A is a plan view of a carrier loaded with wafers which are sufficiently rigid to remain flat when subjected to an accumulation of electrostatic charge.

FIG. 1B is a plan view of a carrier loaded with wafers which are warped due to an accumulation of electrostatic charge.

FIG. 1C is a plan view of the wafers shown in FIG. 1B being transformed from a warped state to a flat state by neutralizing the accumulation of electrostatic charge.

FIG. 2 is a diagram illustrating a system in which one embodiment of the invention can be practiced.

FIG. 3 is a flowchart illustrating a process for fabricating an exemplary semiconductor device in accordance with the system shown in FIG. 2.

FIG. 4 is a schematic diagram of a protective tape applying apparatus in accordance with the system shown in FIG. 2.

FIG. 5 is a schematic diagram of a backgrinding apparatus in accordance with the system shown in FIG. 2.

FIG. 6 is a schematic diagram of a detapping apparatus in accordance with the system shown in FIG. 2.

FIG. 7 is a schematic diagram of a dicing tape applying apparatus in accordance with the system shown in FIG. 2.

FIG. 8 is a schematic diagram of a wafer dicing apparatus in accordance with the system shown in FIG. 2.

FIG. 9 is an alternative exemplary embodiment of a backgrinding apparatus in accordance with the system shown in FIG. 2.

FIG. 10 is another exemplary embodiment in which warped wafers may be flattened by neutralizing the accumulation of electrostatic charge.

### DETAILED DESCRIPTION OF THE INVENTION

Detailed descriptions are provided herein. It is to be understood, however, that the present invention may be embodied in various forms. Therefore, specific details disclosed herein are not to be interpreted as limiting, but rather as a basis for the claims and as a representative for teaching one skilled in the art to employ the invention in virtually any appropriately detailed system, structure or manner.

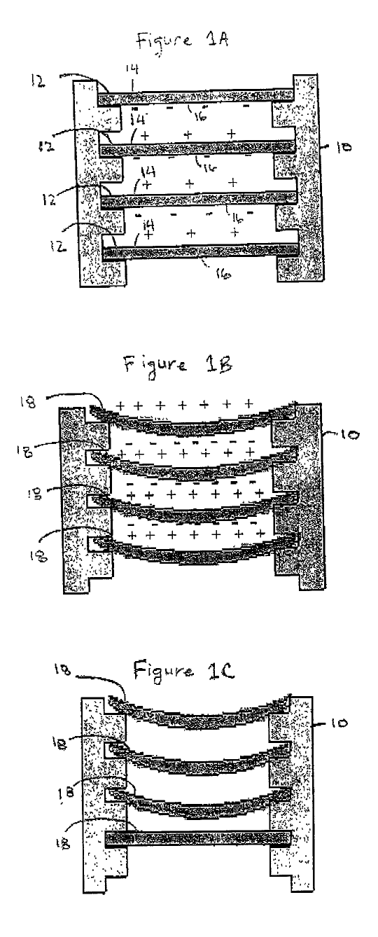

FIG. 1A illustrates a carrier 10 loaded with wafers 12 exhibiting an accumulation of electrostatic charge as a result of a grinding operation. The frontside 14 of the wafers 12 have a net positive charge and the backside 16 of the wafers 12 have a net negative charge as a result of the grinding operation. The wafers 12 remain flat because they are sufficiently rigid to counteract the bending forces resulting from the accumulation of electrostatic charge. It has been observed that 8-inch wafers which are ground to a thickness of about 13 mils thick do not exhibit warpage. Of course, wafer warpage becomes more prominent for a given thickness as the diameter of the wafer increases.

FIG. 1B illustrates the carrier 10 loaded with wafers 18 which are warped after the grinding operation due to an accumulation of electrostatic charge. These wafers 18 are not sufficiently rigid to counteract the bending forces resulting from the accumulation of electrostatic charge. It has been observed that 8-inch wafers, which are ground to a thickness of about 7 mils, exhibit sufficient warpage to negatively affect the handling of wafers. FIG. 1C illustrates the same wafers 18 shown in FIG. 1B wherein the bottom wafer 18 is flattened by neutralizing the accumulation of electrostatic charge with ionized air.

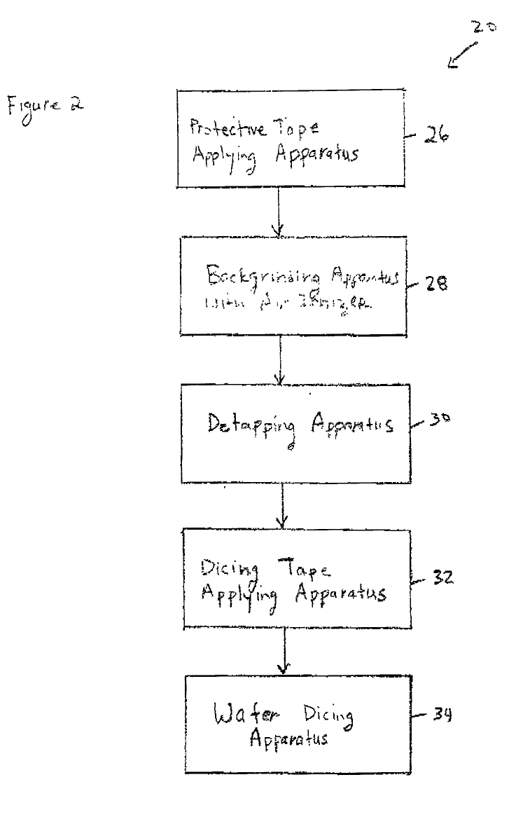

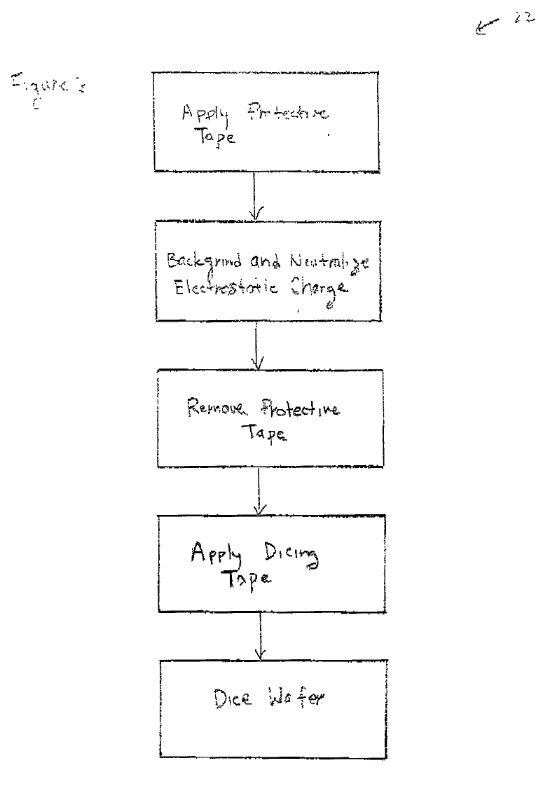

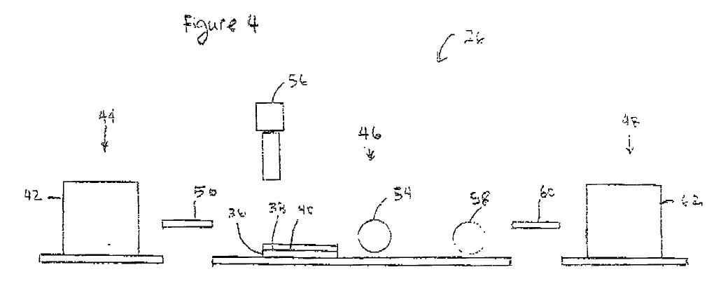

FIG. 2 illustrates a system 20 for performing the backgrinding and dicing process, and FIG. 3 is a flowchart 22 illustrating a process for fabricating the semiconductor device in accordance with the system shown in FIG. 2. The system comprises a protective tape applying apparatus 26, a backgrinding apparatus 28, a detapping apparatus 30, a dicing tape applying apparatus 32, and a wafer dicing apparatus 34. In this particular embodiment, 8-inch wafers 36 having an initial thickness of about 850 microns are utilized. However, it is noted that the system may be adapted to process any sized wafer. After a circuit pattern 38 is formed on the frontside 40 of the wafers 36, the wafers 36 are loaded onto a carrier 42 and transferred to the protective tape applying apparatus 26 as shown in FIG. 4. The protective tape applying apparatus 26 includes a loading station 44, a protective tape applying station 46, and an unloading station 48. An operator places the carrier 42 at the loading station 44. A transfer arm 50 unloads the wafer 36 from the carrier 42 and transfers the wafer 36 to the protective tape applying station 46. A protective tape 52 is dispensed from a roll 54 and laminated onto the frontside 38 of the wafer 36. A cutter 56 cuts the protective tape 52 along the outer edge of the wafer 36, and the protective tape 52 is pressed onto the wafer 36 by a roller 58. A transfer arm 60 transfers the wafer 36 from the protective tape applying station 46 to a carrier 62 located at the unloading station 48. The protective tape application process is repeated until the carrier 62 is fully loaded with wafers 36.

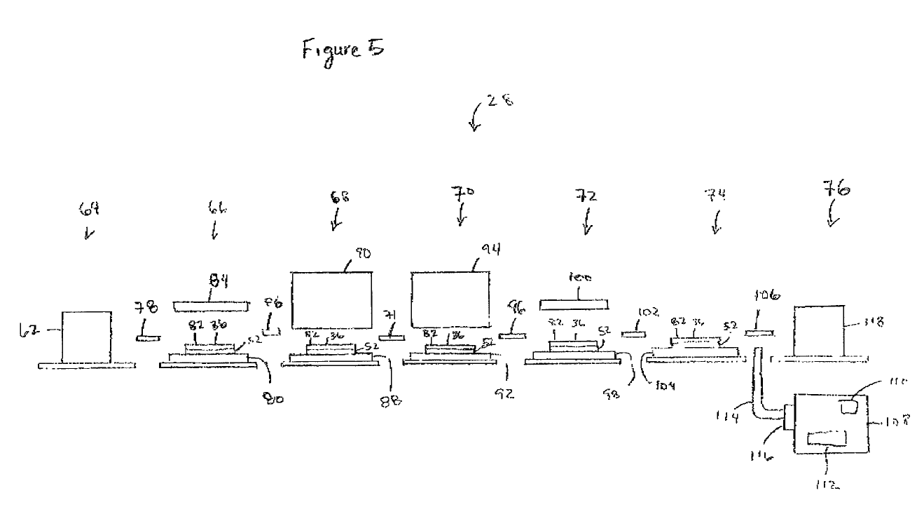

The carrier 62 is then transferred to the backgrinding apparatus 28. Referring to FIG. 5, the backgrinding apparatus 28 includes a loading station 64, a precleaning station 66, a rough grinding station 68, a finish grinding station 70, a post cleaning station 72, a final cleaning station 74, and an unloading station 76. A loader arm 78 transfers the wafer 36 from the carrier 62 to the precleaning station 66. The wafer 36 is secured to a vacuum chuck table 80 such that the protective tape 52 contacts the surface of the vacuum chuck table 80. That is, a backside 82 of the wafer 36 faces upwardly. The vacuum chuck table 80 is rotated and deionized water is dispensed onto the backside 82 of the wafer 36. The backside 36 of the wafer 82 is further cleaned with a Teflon scrubber 84 during the dispensing of deionized water. The wafer 36 is then spin dried with nitrogen air.

With the wafer 36 precleaned, a transfer arm 86 transfers the wafer 36 from the prelceaning station 66 to the rough grinding station 68. The wafer 36 is secured to a vacuum chuck table 88. The size of the vacuum chuck table 88 is larger than the wafer 36, and, thus, the entire surface of the wafer 36 is supported by the vacuum chuck table 88 and fixed on the vacuum chuck table 88 by suction. A course grinding media is dispensed onto the wafer 36, and the thickness of the wafer 36 is reduced to a predetermined thickness by a rough grinding tool 90, such as a diamond wheel, directed onto the backside 82 of the wafer 36. In the examplary embodiment, the wafer 36 is reduced from a thickness of about 32 mils to about 7±0.5 mils. The protective tape 52 protects the frontside 40 of the wafer 36 and also acts as a cushion to absorb a pressing force exerted by the rough grinding tool 90 during the grinding operation. However, one problem resulting from the use of the protective tape 52 is that an electrostatic charge may accumulate on the protective tape 52 during the grinding operation.

After the rough grinding is completed, the wafer 36 is transferred from the rough grinding station 68 to the finish grinding station 70 by a transfer arm 71. The wafer 36 is secured to a vacuum chuck table 92. A fine grinding media is dispensed and a finish grinding tool 94 is directed onto the backside 82 of the wafer 36 to remove defects such as scratches formed during the rough grinding operation. As such, the thickness of the wafer 36 is reduced primarily during the rough grinding operation while the finish grinding operation simply polishes the backside 82. Similarly, a further accumulation of electrostatic charged may be formed during the finish grinding operation.

After the finish grinding is completed, the wafer 36 is transferred from the finish grinding station 70 to the post cleaning station 72 by a transfer arm 96. The wafer 36 is secured to a vacuum chuck table 98, and deionized water and a scrubber 100 are directed to the backside 82 of the wafer 36 to remove the residual grinding media. The wafer 36 is then spin dried with nitrogen air. To further clean the wafer 36, a transfer arm 102 transfers the wafer 36 from the post cleaning station 72 to the final cleaning station 74 where the wafer 36 is secured to a vacuum chuck table 104 and rinsed with deionized water and spin dried with nitrogen air.

The wafer 36 is then treated with ionized air during the transfer from the final cleaning station 74 to the unloading station 76. An unloader arm 106 removes the wafer 36 from the vacuum chuck table 104 of the final cleaning station 74 and moves the wafer 36 to at an interim location within the unloading station 76. While at the interim position, ionized air is directed towards the wafer 36 to neutralize the accumulation electrostatic charge. The ionized air may be provided by an air ionizing source 108 such as a Model A-300 manufactured by Simco Aerostat. The air ionizing source 108 is an electrically powered static eliminator that blows ionized air to neutralize static charges on materials. An electronic balancing circuit 110 is provided to control the ion output ratio of negative-to-positive ions. Typically, the electronic balancing circuit 110 is set to produce an ion output with an equal number of negative and positive ions. A control 112 on a front panel provides adjustment of the fan speed. The ionized air is directed towards the interim location by a duct 114 coupling an output vent 116 of the air ionizing source 108 with the unloading station 76. By using an ESD meter, it has been observed that a static charge of about 4 to 6 Kvolts is typically accumulated at the wafer 36 after completion of the finish grinding operation. After subjecting the wafer 36 with ionized air for approximately 5-10 minutes, the static charge is reduced to approximately 0.2 to 0.4 Kvolts. Of course, an air ionizer with a greater ion output may be provided to shorten the neutralizing time. With the wafer 36 transformed from a warped state to a flat state, the unloading arm 106 feeds the wafer 36 into a carrier 118 located at the unloading station 76.

With respect to the backgrinding apparatus 28, the operation described above is repeated for processing subsequent wafers 36. It is noted that a wafer 36 is located at each station 64, 66, 68, 70, 72, 74, 76 during the operation of the backgrinding apparatus 28. In other words, the following operations are performed simultaneously: a first wafer 36 is unloaded from the carrier 62 at the unloading station 64, a second wafer 36 is cleaned at the precleaning station 66, a third wafer 36 is ground at the rough grinding station 68, a fourth wafer 36 is ground at the finish grinding station 70, a fifth wafer 36 is cleaned at a post cleaning station 72, a sixth wafer 36 is cleaned at the final cleaning station 74, and a seventh wafer 36 is neutralized and loaded into a carrier 118 at the unloading station 76. After the wafer 36 is loaded into the carrier 118 at the unloading station 76, the carrier 118 is indexed such that an empty slot is available to accept the next wafer 36. Since each of the wafers 36 are flat as a result of neutralizing the accumulation of electrostatic charge, the unloading arm 106 is able to load the wafer 36 into the carrier 118 without difficulty. In particular, there is sufficient clearance for the unloading arm 106 to feed the wafer 36 into the carrier 118.

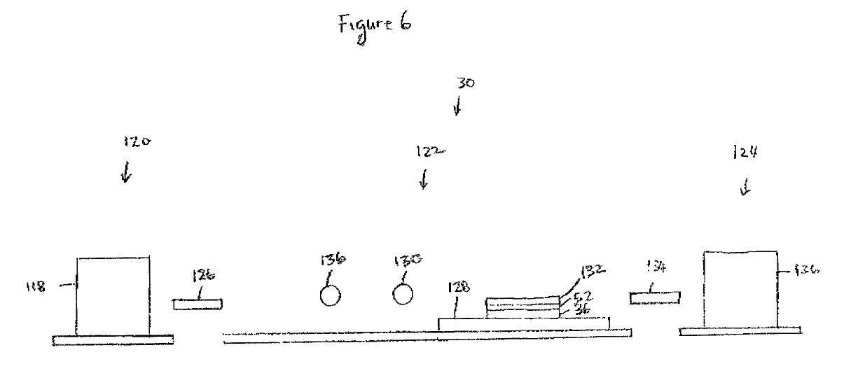

Referring to FIG. 6, the protective tape 52 from each wafer 36 is removed at the detapping apparatus 30. The detapping apparatus 30 comprises a loading station 120, a tape removing station 122, and an unloading station 124. The operator transfers the carrier 118 from the unloading station 76 of the backgrinding apparatus 28 to the loading station 120 of the detapping apparatus 30. A transfer arm 126 unloads the wafer 36 from the carrier 118, and transfers the wafer 36 to a chuck 128 located at the tape removing station 122. An uncoiler 130 dispenses a peeling tape 132 from a coil 134 and applies the peeling tape 132 onto the protective tape 52. A roller 136 presses the peeling tape 132 onto the protective tape 52 to further bond the peeling tape 132 to the protective tape 52. By heating the chuck 128, an adhesive layer of the protective tape 52 is softened. The peeling tape 132 is then recoiled onto the coil 134. As the peeling tape 132 is recoiled, the protective tape 52 is peeled away from the frontside 40 of the wafer 36 because the protective tape 52 remains bonded to the peeling tape 132 during the recoiling operation. With the completion of the detapping operation, the wafer 36 is transferred from the tape removing station 122 to the unloading station 124, wherein a transfer arm 134 loads the wafer 36 into a carrier 136 located at the unloading station 124. The remaining wafers 36 are processed in a similar fashion.

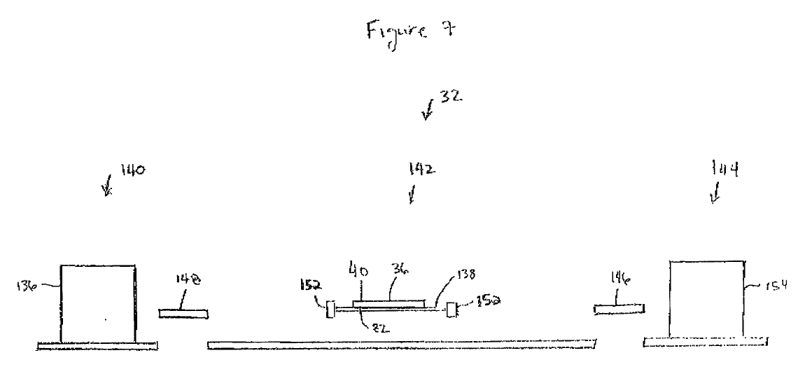

Referring to FIG. 7, a dicing tape 138 is applied to the backside 82 of the wafer 36 by the dicing tape applying apparatus 32. The dicing tape applying apparatus 32 comprises a loading station 140, dicing tape applying station 142, and an unloading station 144. The operator transfers the carrier 136 from the unloading station 124 of the detapping apparatus 30 to the loading station 140 of the dicing tape applying apparatus 32. A transfer arm 148 transfers the wafer 36 from the loading station 140 to the dicing tape applying station 140. At the dicing tape applying station 140, the wafer 36 is applied to the dicing tape 138 which is spread on a wafer frame 152 so that the frontside 40 of the wafer 36 faces upwardly. The dicing tape 138 is formed of a resin, and a pressure sensitive adhesive is applied to the surface of the dicing tape 138. The assembly, which comprises the wafer frame 152, dicing tape 138, and wafer 36, is then transferred from the dicing tape applying station 142 to a carrier 154 at the unloading station 144 by a transfer arm 146. The remaining wafers 36 are processed in a similar fashion.

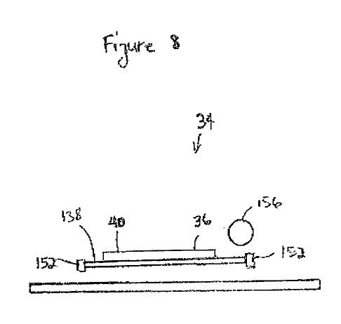

Referring to FIG. 8, the wafer 36 is diced by the wafer dicing apparatus 34 wherein the wafer 36 is diced by a dicing saw 156. The dicing is performed while monitoring an image of a scribe line formed on the frontside 40 of the wafer 36. Thereby, the wafer 36 is divided into a plurality of semicondcutor chips.

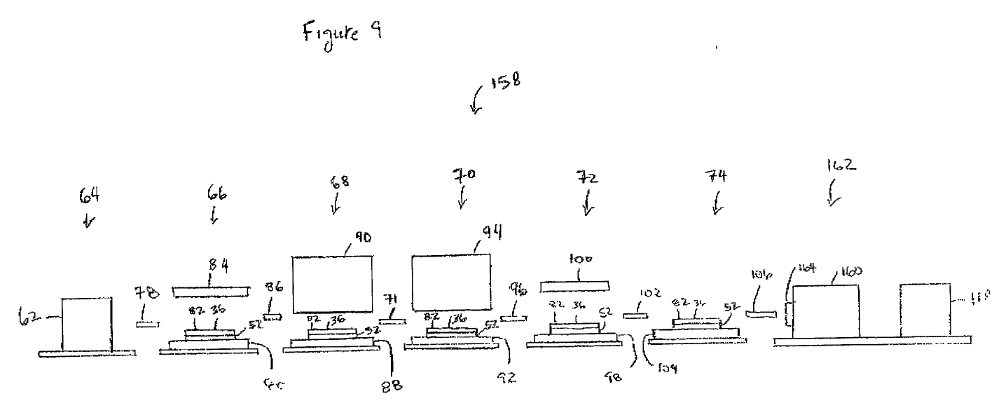

FIG. 9 illustrates another exemplary embodiment of a backgrinding apparatus 158. The backgrinding apparatus 158 is similar to the backgrinding apparatus 28 illustrated in FIG. 5 with the exception that an air ionizing source 160 is located within an unloading station 162. As such, similar elements are identified with the same reference numeral. The Model A-300 air ionizing source may be used or any other source which may fit within the unloading station. The air ionizing source 160 is positioned so that an output vent 164 directs the ionized air towards the interim position of the transfer arm 106. As such, a duct is not required. After the background wafers 36 are neutralized, they may be processed in accordance with the processes described in FIGS. 6-8.

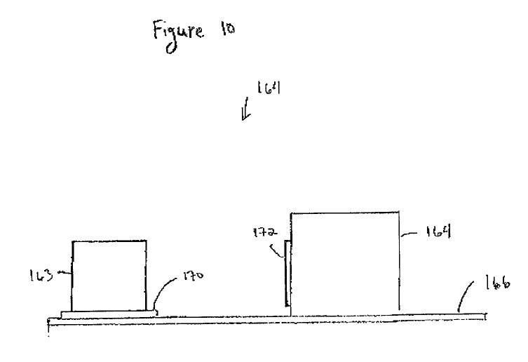

FIG. 10 illustrates another exemplary embodiment in which the warped wafers 36 may be flattened by neutralizing the accumulation of electrostatic charge. The backgrinding apparatus is similar to the backgrinding apparatus 28 illustrated in FIG. 5 with the exception that an air ionizing source is not provided. In this application, the background wafers 36 are sufficiently flat such that it is not necessary to neutralize the accumulation of electrostatic charge prior to post cleaning station, final cleaning station, and unloading. After the wafers 36 are processed through the backgrinding apparatus, a carrier 163 is transferred to an air ionizing apparatus 164 to flatten the wafers 36. The air ionizing apparatus 164 comprises a table 166, an air ionizing source 168 such as the Model A-300 positioned on the table 166, and a receiving member 170 positioned on the table 166 and approximately 8 to 12 inches from the air ionizing source 168. The carrier 163 is placed on the receiving member 170, and the air ionizing source 168 is activated. An output vent 172 of the air ionizing source 168 directs the ionized air towards the carrier 163 and background wafers 36. Generally, the background wafers 36 are subjected to the ionized air for approximately 5-10 minutes to adequately neutralize the accumulation of static charge. Since the entire batch of background wafers 36 are simultaneously neutralized, this exemplary embodiment is particularly advantageous for systems requiring a relatively high process throughput. After the background 36 wafers are sufficiently neutralized, they may be processed by the detapping apparatus 30, dicing tape applying apparatus 32, and wafer dicing apparatus 34.

In certain applications, air ionization may not be required prior to post cleaning and final cleaning. However, the background wafers 36 may not be sufficiently flat for subsequent handling at the unloading station of the backgrinding apparatus. In this situation, the background wafers 36 may be loaded onto the carrier 163 at the unloading station of the backgrinding apparatus without electrostatic charge neutralization if half the slots of the carrier 163 are loaded with the background wafers 36. In other words, an empty slot is provided between each background wafer 36 to provide sufficient clearance during the loading and unloading process. The carrier 163 may then be processed at the air ionizing apparatus 164 to neutralize the accumulation of electrostatic charge. After the background wafers 36 are sufficiently neutralized, they may be processed by the detapping apparatus 30, dicing tape applying apparatus 32, and wafer dicing apparatus 34.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative manner rather than a restrictive sense.

What is claimed is:

1. A method comprising:
directing ionized air at a substrate to reduce substrate warpage, the ionized air reducing an accumulation of electrostatic charge.

2. The method of claim 1, further comprising:
applying a protective tape on a frontside of the substrate before said directing ionized air at the substrate; and
grinding a backside of the substrate before said directing ionized air at the substrate.

3. The method of claim 2, further comprising:
forming a circuit pattern on the frontside of the substrate before said applying a protective tape on the frontside of the substrate.

4. The method of claim 3, wherein the substrate is a semiconductor wafer.

5. The method of claim 2, wherein said applying the protective tape on the frontside of the substrate comprises:
laminating the protective tape to the front surface of the substrate;
cutting the protective tape along a contour of a substrate edge; and
roller pressing the protective tape onto the frontside of the substrate.

6. The method of claim 2, wherein said grinding the backside of the substrate comprises:
cleaning the substrate;
rough grinding the backside of the substrate at a first grinding station;
finish grinding the backside of the substrate at a second grinding station; and
cleaning the substrate.

7. The method of claim 2, wherein said directing ionized air at the substrate comprises:
loading the substrate onto a carrier after said grinding the backside of the substrate; and
simultaneously directing negatively and positively charged air ions onto the substrate and protective tape to reduce an accumulation of electrostatic charge resulting from said grinding the backside of the substrate.

8. The method of claim 7, wherein the negatively and positively charged air ions are simultaneously directed onto the substrate and protective tape for 5 to 10 minutes to decrease the accumulation of electrostatic charge decreases from approximately 4 to 6 Kvolts to approximately 0.2 to 0.4 Kvolts.

9. The method of claim 2, wherein said directing ionized air at the substrate comprises:
directing ionized air at the substrate prior to loading the substrate into a carrier.

10. An apparatus comprising:
a grinder to reduce the thickness of a substrate; and
an air ionizing source to direct ionized air onto the substrate, the ionized air reducing an accumulation of electrostatic charge on the substrate to reduce substrate warpage.

11. The apparatus of claim 10, wherein the substrate is a semiconductor wafer.

12. The apparatus of claim 11, wherein a frontside of the semiconductor wafer has a circuit pattern, and the grinder grinds a backside of the semiconductor wafer.

13. The apparatus of claim 10, further comprising:
a duct to direct the ionized air from the air ionizing source to the substrate.

14. The apparatus of claim 10, wherein the grinder comprises a rough grinding station and a fine grinding station.

15. The apparatus of claim 14, further comprising:
a loading station to receive a first carrier loaded with a plurality of the substrates;
a precleaning station to clean the substrates prior to grinding;
a final cleaning station to clean the substrates after grinding; and
an unloading station to load the substrates into a second carrier.

16. The apparatus of claim 15, wherein ionized air is directed onto the substrate prior to loading the substrate into the second carrier.

17. The apparatus of claim 15, wherein the ionized air is directed onto the substrate after loading the substrate into the second carrier.

18. The apparatus of claim 10, wherein a protective tape covers a surface of the substrate, and wherein the ionized air reduces an accumulation of electrostatic charge on the protective tape to reduce substrate warpage.

19. A system comprising:
a protective tape applying apparatus to apply a protective tape on a substrate;
a grinding apparatus to reduce a thickness of the substrate; and
an air ionizing source directing ionized air onto the substrate to reduce an accumulation of electrostatic charge on the substrate and the protective tape.

20. The system of claim 19 further comprising:
a detapping apparatus to remove the protective tape;
a dicing tape applying apparatus to apply a dicing tape on the substrate; and
a wafer dicing apparatus to divide the substrate into a plurality of devices.

21. The system of claim 20, wherein the substrate is a semiconductor wafer, and wherein the plurality of devices are a plurality of semiconductor chips.

22. The system of claim 19, wherein the grinding apparatus is a backgrinder to grind a backside of the substrate, and the protective tape covers a frontside of the substrate.

23. An apparatus comprising:
a table;
a receiving member coupled to the table, the receiving member to receive a carrier loaded with a plurality of substrates, the plurality of substrates being warped; and
an air ionizing source to direct ionized air onto the plurality of substrates and carrier to reduce substrate warpage, the substrate warpage being reduced by decreasing the accumulation of electrostatic charge on the plurality of substrates.

24. The apparatus of claim 21, wherein backsides of the plurality of substrates are covered with a protective tape, and wherein the plurality of substrates are background substrates, and wherein the ionized air decreases the accumulation of electrostatic charge on the protective tape.

25. The apparatus of claim 24, wherein the plurality of substrates are semiconductor wafers.

26. The apparatus of claim 23, wherein the air ionizing source has an electronic balancing circuit to control an ion output ratio of negative-to-positive ions.

27. The apparatus of claim 26, wherein the electronic balancing circuit is set to produce an ion output with an equal number of negative and positive ions.
